(19) United States
(12) Patent Application Publication
(10) Pub. No.: US 2008/0268396 A1
(43) Pub. Date: Oct. 30, 2008

(54) Active control of time-varying spatial temperature distribution

(76) Inventors: Duncan Stewart, Menlo Park, CA (US); Raymond G. Beausoleil, Redmond, OR (US); Philip J. Kuekes, Menlo Park, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/796,515

(22) Filed: Apr. 26, 2007

(51) Int. Cl. F27D 19/00

(52) U.S. Cl. 432/49

(57) ABSTRACT

In an embodiment, a microchip includes a plurality of heat-producing electronic devices and a plurality of heat-sensitive devices. A plurality of temperature control elements are spatially distributed relative to the heat-producing electronic devices and the heat-sensitive devices to enable active control of temperature to compensate for spatially non-uniform and temporally-varying heat emitted from the heat-producing electronic devices.

### BACKGROUND

Microcircuits increasingly include a variety of disparate technologies. For example, considerable research is being conducted into the use of photonic interconnect for complementary metal-oxide-semiconductor (CMOS) digital circuits to overcome the limitations of metal-based interconnect. For example, silicon-based CMOS devices may be fabricated on a first wafer and indium-phosphide-based photonic devices fabricated on a second wafer. The first and second wafers are then bonded together to complete the microcircuit.

One significant difficulty in combining disparate technologies is the issue of heat management. For example, CMOS digital circuits can generate very high amounts of heat (e.g., 100 W/cm²). While CMOS is relatively insensitive to heat, it is necessary to remove heat from the microcircuit to avoid damage to the devices if too much heat is allowed to build up. Typically, heat removal has involved the attachment of the microcircuit to a heat sink of some type.

Some technologies, however, are very sensitive to heat. For example, photonic devices such as waveguides, resonators, transceivers, lattices, etc. can be very sensitive to small temperature changes (e.g., 0.1 degree C.). When heat-sensitive devices are placed in close proximity to heat-producing devices, the performance of the heat-sensitive devices may be compromised. Unfortunately, there is a desire to produce highly integrated microcircuits that combine disparate device types, and so it is not always possible to provide a separation between heat-sensitive and heat-producing devices. While heat sinks can help to remove heat from a microcircuit, any variations in the rate of heat production can result in variations in the temperature of the microcircuit, in turn affecting the operation of devices within the microcircuit.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1 is side view illustration of a microcircuit having active temperature control in accordance with an embodiment of the present invention;

FIG. 2 is side view illustration of a microcircuit having active temperature control in accordance with another embodiment of the present invention;

FIG. 3 is side view illustration of a microcircuit having active temperature control in accordance with another embodiment of the present invention;

FIG. 4 is side view illustration of a microcircuit having active temperature control in accordance with another embodiment of the present invention;

FIG. 5(a) is side view illustration of a microcircuit having active temperature control in accordance with another embodiment of the present invention;

FIG. 5(b) is a top view illustration of the microcircuit of FIG. 5(a);

FIG. 6 is block diagram of a feedback control system for a microcircuit in accordance with another embodiment of the present invention;

FIG. 7 is a side view illustration of one arrangement of control system elements for a microcircuit having active temperature control in accordance with an embodiment of the present invention;

FIG. 8 is a side view illustration of one arrangement of control system elements for a microcircuit having active temperature control in accordance with another embodiment of the present invention;

FIG. 9 is a side view illustration of one arrangement of control system elements for a microcircuit having active temperature control in accordance with another embodiment of the present invention; and

FIG. 10 is a flow chart of a method of making a microchip having active temperature control in accordance with an embodiment of the present invention.

### DETAILED DESCRIPTION OF EXAMPLE EMBODIMENTS

In describing embodiments of the present invention, the following terminology will be used.

The singular forms “a,” “an,” and “the” include plural referents unless the context clearly dictates otherwise. Thus, for example, reference to “a device” includes reference to one or more of such devices.

As used herein, the term “about” means that dimensions, sizes, formulations, parameters, shapes and other quantities and characteristics are not and need not be exact, but may be approximated and/or larger or smaller, as desired, reflecting tolerances, conversion factors, rounding off, measurement error and the like and other factors known to those of skill in the art.

Reference will now be made to the exemplary embodiments illustrated, and specific language will be used herein to describe the same. It will nevertheless be understood that no limitation of the scope of the invention is thereby intended.

In view of the difficulties presented by integrating heat-producing devices and heat-sensitive devices into a microcircuit, it has been recognized by the present inventors that improved techniques for managing heat within a microcircuit are desirable. Accordingly, embodiments of the present invention include techniques for active temperature control within a microcircuit to allow compensation of spatially non-uniform and temporally-varying heat. For example, a plurality of temperature control elements can be included within the microcircuit and controlled to compensate for spatially non-uniform and temporally-varying heat emitted from heat-producing devices within the microcircuit. This can help to provide improved uniformity of temperature for heat-sensitive devices within the microchip.

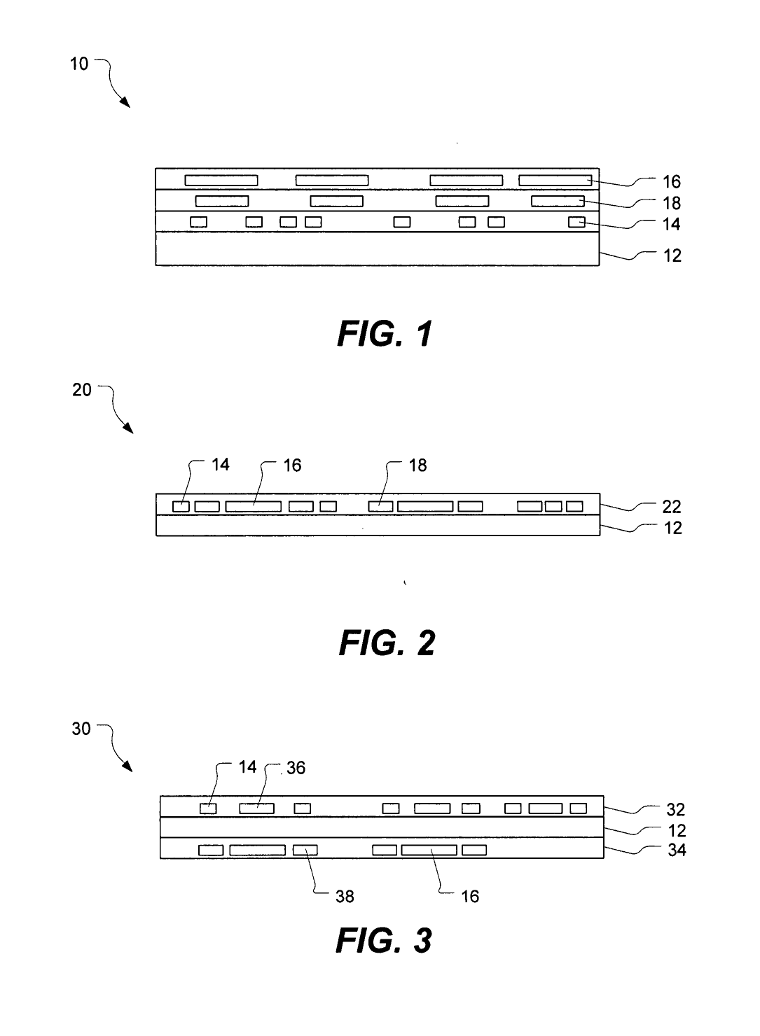

One exemplary embodiment of the present invention is a microchip having active temperature control as illustrated in side view in FIG. 1. The microchip, shown generally at 10, includes a substrate 12 on which a plurality of heat-producing electronic devices 14 are supported. For example, the heat-producing electronic devices may include devices such as CMOS transistors and the like. When operated, the heat-producing electronic devices emit heat characterized by a spatially non-uniform and temporally-varying heat distribution. For example, in a processor microcircuit, depending on the type of operations being performed, different portions of the processor circuitry will be active, resulting in a different spatial distribution of heat as a function of time.

Also supported by the substrate 12 is a plurality of heat-sensitive devices 16 in proximity to the heat-producing electronic devices 14. The heat-sensitive devices may be in a different layer than the heat-producing electronic devices (as shown here), or the heat-sensitive electronic devices may be interspersed with the heat-producing electronic devices within a common layer as described further below. The heat-sensitive devices may be, for example, passive optical devices (e.g., add/drop filters, waveguides, etc.) or electro-optical devices (e.g., modulators, detectors, etc.) and combinations thereof.

A plurality of temperature control elements 18 are also supported by the substrate 12 and spatially distributed relative to the heat-producing electronic devices 14. The temperature control elements can be actively controlled to compensate for the spatially non-uniform and temporally-varying heat emitted from the heat-producing devices. For example, the temperature control elements can include a temperature sensor, a heating element, a cooling element, and multiples and combinations thereof. For example, thermistors, P-N semiconductor junctions, and the like can function as temperature sensors. As another example, a temperature sensor can be formed by measuring an output of a temperature-sensitive component. More particularly, a center frequency of a temperature-sensitive photonic transmitter can provide information regarding temperature of the photonic transmitter. Heating devices can include resistive heaters (e.g. wires formed from platinum, tantalum, or polysilicon), and combinations thereof. Cooling devices can include thermo electric coolers, and the like, and combinations thereof.

The microcircuit 10 may be fabricated, for example, as follows. The heat-producing electronic devices 14 and temperature control elements 18 may be fabricated on a first substrate (e.g. a silicon wafer). The heat-sensitive electronic devices 16 may be fabricated on a second substrate (e.g. a silicon on insulator wafer or a III-V semiconductor wafer). The first and second substrate may then be brought together and bonded together to form the microchip. If desired, the second substrate may be separated from the heat-sensitive devices after bonding to leave the heat-sensitive devices supported only by the first substrate.

Various arrangements of the heat-sensitive devices, heat-producing electronic devices, and temperature control elements are possible. For example, FIG. 2 illustrates an alternate arrangement of a microcircuit 20, wherein heat-producing electronic devices 14, heat-sensitive devices 16, and the temperature control elements 18 are disposed within a common layer 22 on a substrate 12. Fabrication of the microcircuit may be, for example, using a multi-step process which lays down the different device types on different areas of the substrate, using photolithography as is known in the art.

FIG. 3 illustrates another alternate arrangement of a microcircuit 30, wherein heat-producing electronic devices 14 are disposed in a first region 32 on a first side of a substrate 12 and heat-sensitive devices 16 are disposed in a second region 34 on the opposite side of the substrate. Temperature control elements 36, 38 can be distributed on either side of the substrate, or included on both sides. In other words, the temperature control elements can be included in a common plane with the heat-sensitive devices. Alternately, the temperature control elements can be included in a common plane with the heat-producing electronic devices. Which configuration is better may depend on the application. For example, the temperature control elements may be more easily fabricated in CMOS technology, in which case it would be desirable to include the temperature control elements on the same side as the CMOS devices. Other considerations in placement of the temperature control elements are discussed below. Various ways of fabricating the microcircuit 30 can be used, including for example, two-sided fabrication on a single wafer and bonding together two or more wafers to form a completed device.

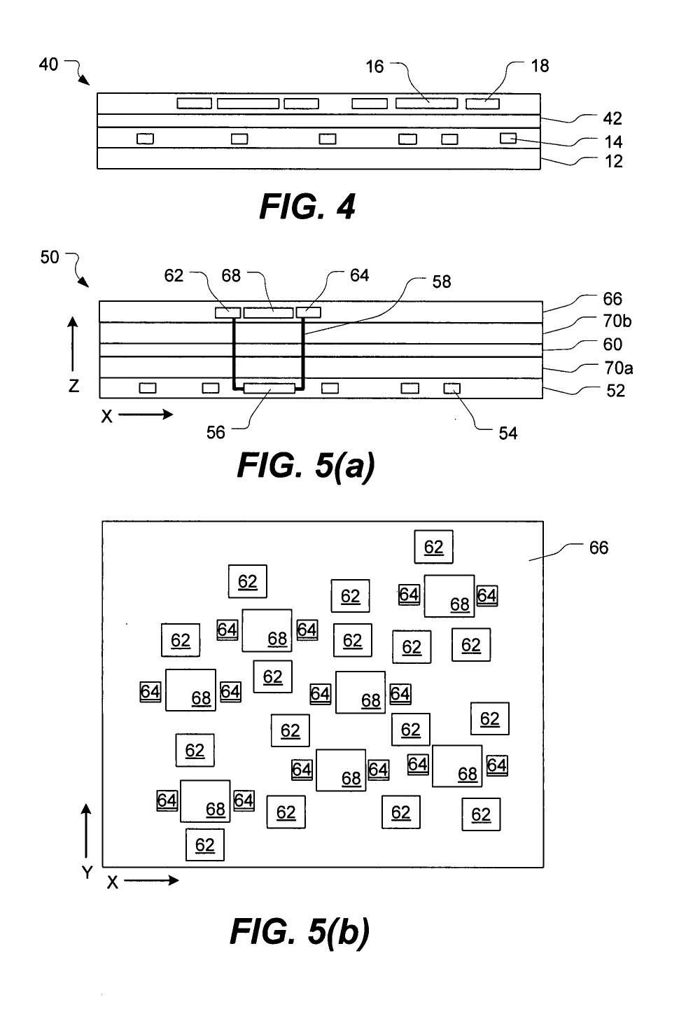

In another embodiment, the microcircuit can include one or more heat-insulating layers to help distribute heat. For example, FIG. 4 illustrates a microcircuit 40, wherein an insulating layer 42 is positioned between the heat-producing electronic devices 14 and the heat-sensitive electronic devices 18. The insulating layer helps to even out the spatial distribution of heat flowing from the heat-producing electronic devices towards the heat-sensitive electronic devices. The temperature control elements 18 are positioned within the same plane as the heat-sensitive devices 16, allowing for fine control of the temperature of the heat-sensitive devices.

Operation of a microchip with active temperature control will now be explained in further detail with reference to an exemplary embodiment illustrated in FIGS. 5(a) and 5(b). The microchip 50 includes a heat-producing device layer 52, in which a plurality of heat-producing CMOS devices 54 are disposed. Included within the CMOS layer is feedback control circuitry 56. The feedback control circuitry is interconnected through vertical conductive vias 58 through an insulating layer 60 to at least one temperature sensor 62 and at least one temperature control element 64 within a heat-sensitive device layer 66. The heat-sensitive device layer includes a plurality of heat-sensitive photonic devices 68. Electrical interconnect layers 70a, 70b may also be included.

When operated, the heat-producing CMOS devices 54 emit heat, which is conducted (in the Z direction) towards the heat-sensitive photonic devices 68, through the insulating layer 60 and (if present) electrical interconnect layers 70a, 70b. The heat is sensed by the temperature sensor 62. By including multiple temperature sensors, the spatial distribution of temperature within the microchip can be sensed. In particular, the temperature may vary horizontally (X and Y coordinates) over the heat-sensitive device layer 66. The output of the temperature sensor(s) 62 is provided to the feedback control circuitry 56, which can control the temperature control element(s) 64 to compensate for the time-varying spatial distribution of temperature. By including a distribution of temperature control elements over the heat-sensitive device layer, the spatial variation can be compensated for. The temperature control elements may be adjusted continuously using a feedback control loop to compensate for time variations. As another example, the temperature control elements may be adjusted periodically to compensate for time variations, for example, using a sampled time control loop (e.g., with a microprocessor or microcontroller performing calculations to close a feedback control loop).

If desired, control of the temperature control element(s) 64 can include predicting the time-varying spatial distribution of temperature. For example, where the microcircuit includes a microprocessor, based on the type of instructions being executed by the microprocessor, the heat generation that will occur may be predicted beforehand (for both time and space variations). Prediction of the heat generation may allow improved performance of the active temperature control.

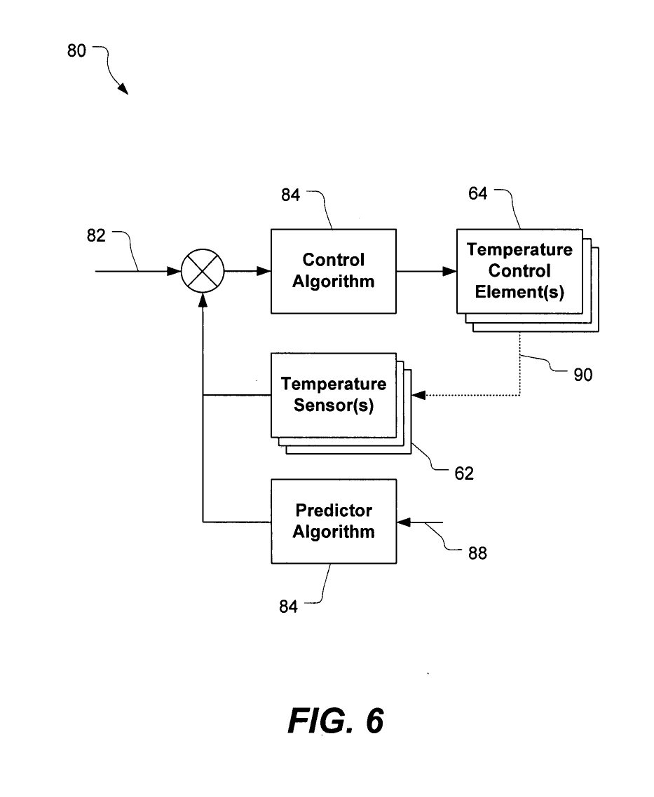

FIG. 6 illustrates a block diagram of a feedback control loop in accordance with an embodiment of the present invention. The feedback control loop 80 includes a reference value 82 corresponding to a desired temperature. The reference value can be compared to the temperature measured by the temperature sensor(s) 62. A control algorithm 84 determines how the temperate control element(s) 64 are driven. For example, heating, cooling, or both types of temperature control elements may be activated based on the difference between the reference value and the measured temperature. The temperature control elements will be determined by heat flow 90 within the chip, with heat flow being affected by the heat-producing devices, the structure of the microchip, and the temperature control elements. The feedback control loop may be implemented in hardware devices (e.g. using transistors, amplifiers, filters, and the like included within the microcircuit. Alternately, the feedback control loop may be implemented in whole or in part using a microprocessor or microcontroller included within the microcircuit.

Various feedback control loop algorithms including, for example, bang-bang, proportional, proportional-integral-derivative, and the like may be used. The feedback control loop 80 may include multiple feedback paths, for example, where temperature sensors 62 are included in locations near the heat-producing electronic devices and in locations near the heat-sensitive devices. A predictor algorithm 86 can accept inputs 88 such as, for example, electronics computation load information, to predict additional heating/cooling needs which are fed into the control algorithm.

With the temperature sensors(s) 62 positioned as shown in FIGS. 5(a) and 5(b), the time-varying spatial distribution of temperature is sensed within the photonic device layer 66. As noted above, however, alternate arrangements can also be used. For example, the temperature sensors can be positioned within the heat-producing device layer 52 instead of within the heat-sensitive device layer 66, or temperature sensors can be included in both the heat-producing device layer and the heat-sensitive device layer. For example, temperature sensors positioned near the heat-producing devices may provide for faster response and prediction of temperature, however, temperature sensors positioned near the heat-sensitive devices may provide for more accurate control of temperature at the heat-sensitive devices.

The temperature control element(s) 64 can be also be positioned within either the heat-producing device layer 52, within the heat-sensitive device layer 66, or within both. As for the temperature sensor(s) 62, different performance may be obtained depending on where the temperature control elements are positioned. For example, by positioning the temperature control elements near the heat-producing devices, faster response to changes in the temporal or spatial characteristics of the heat may be obtained. On the other hand, positioning the temperature control elements near the heat-sensitive devices may provide for more accurate control in the temperature of the heat-sensitive devices. Which configuration will perform better will depend on the particular application characteristics. If desired, temperature sensors and temperature control elements may be included in a variety of locations and used within a multiple feedback loop control system.

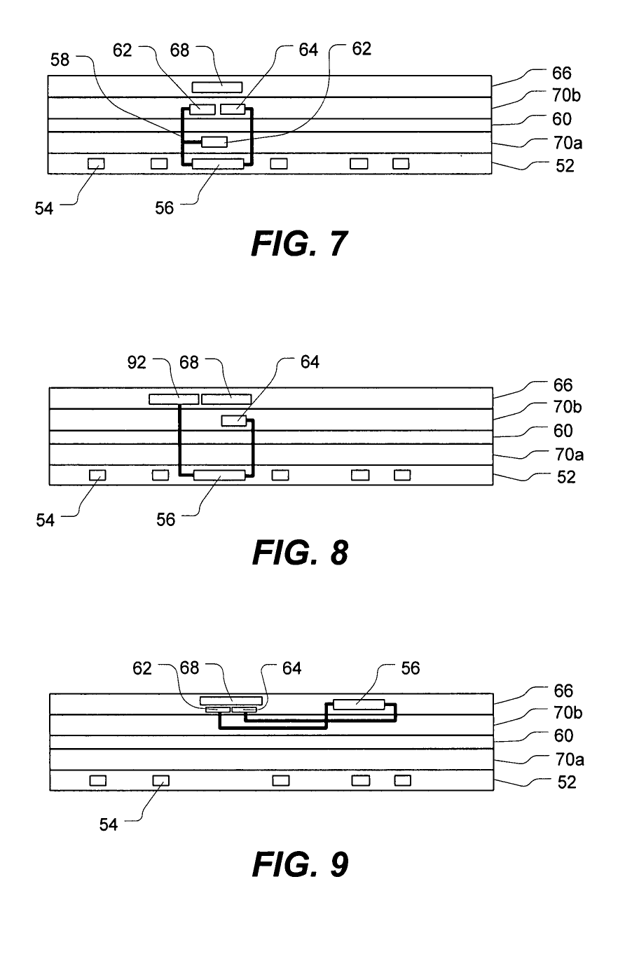

For example, FIG. 7 illustrates an alternate arrangement of a microcircuit where temperature sensors 62 are included within the electrical interconnect layers 70a, 70b. For example, the electrical interconnect layers may include electrically-insulating material (e.g. SiO₂), conductive traces (e.g. aluminum or copper), and thermistors. Interconnect to other layers may be through conductive vias as described above.

FIG. 8 illustrates another alternate arrangement of a microcircuit where a photonic element 92 operates as the temperature sensor, for example as mentioned above. FIG. 9 illustrates yet another alternate arrangement where the temperature control elements are all located within the same layer as the photonic devices.

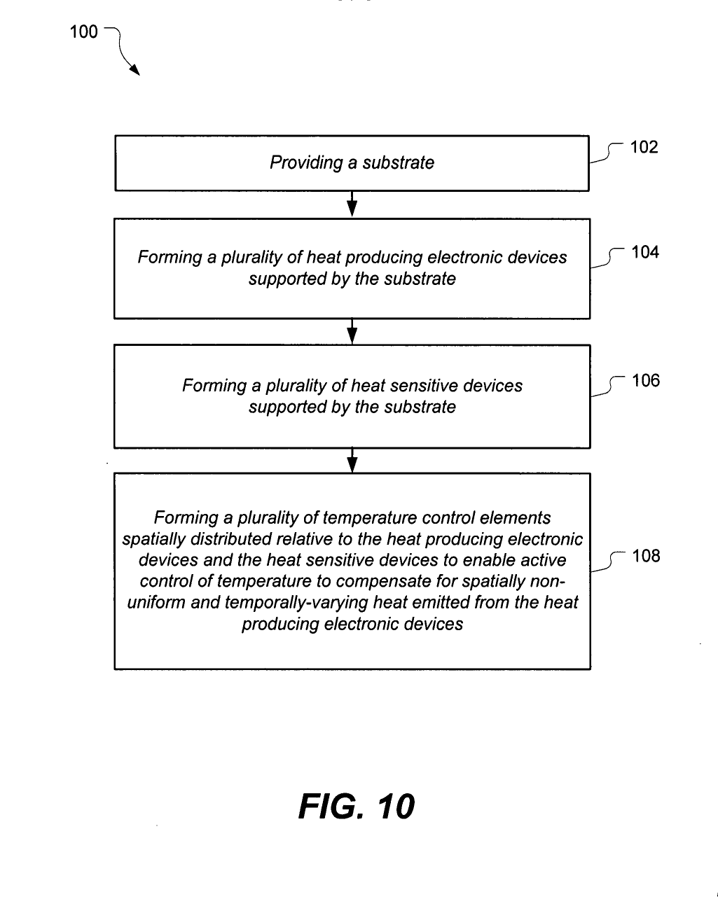

Finally, a method of making a microchip having active temperature control is illustrated in flow chart form in FIG. 10. The method, shown generally at 100, includes providing 102 a substrate. For example, the substrate may be a silicon wafer. The method also includes forming 104 a plurality of heat-producing electronic devices supported by the substrate. For example, heat-producing electronic devices may be fabricated using photolithography as known in the art. As a particular example, the heat-producing electronic devices may be CMOS devices, as described above.

The method 100 may also include forming 106 a plurality of heat-sensitive devices supported by the substrate. For example, the heat-sensitive devices may be fabricated using photolithography. The heat-sensitive devices may be formed on top of, underneath, or within a common layer as the heat-producing electronic devices, for example as described above. The heat-sensitive devices may be formed on a separate wafer that is bonded to the substrate. The heat-sensitive devices may be photonic devices, as described above.

Another step of the method 100 can include forming 108 a plurality of temperature control elements spatially distributed relative to the heat-producing electronic devices and the heat-sensitive devices. The temperature control elements may be placed in various positions relative to heat-producing electronic devices and the heat-sensitive devices as described above. For example, the temperature control elements may be fabricated at the same time as the heat-sensitive devices, as described above.

It will be appreciated that the various fabrication steps can be performed in differing orders, including performing some steps simultaneously. Forming devices can be performing using photolithography as known in the art.

Summarizing and reiterating to some extent, a microcircuit having active temperature control in accordance with embodiments of the present invention can provide improved performance for heat-sensitive devices included within the microchip. Temporally and spatially varying heat flux produced by heat-producing devices within the microchip is sensed and compensated for via active control loops. Temperature sensing devices and temperature control devices can be distributed within the microchip as desired to provide temperature controlled regions within the microchip. Multiple regions having independent active temperature control systems can be implemented.

Active control of temperature with a microcircuit as described herein can enable temperature-sensitive devices, such as photonic components, to be used even when proximate to high heat-producing devices, such as CMOS devices. By maintaining a steady temperature for the temperature-sensitive devices, improved frequency stability, amplitude stability, and similar characteristics may be obtained.

While the foregoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A microchip having active temperature control, comprising:
a substrate;
a plurality of heat-producing electronic devices supported by the substrate, the heat-producing electronic devices emitting heat characterized by a spatially non-uniform and temporally-varying heat distribution when operated;
a plurality of heat-sensitive devices supported by the substrate in proximity to the heat-producing electronic devices; and
a plurality of temperature control elements supported by the substrate and spatially distributed relative to the heat-producing electronic devices and the heat-sensitive devices to enable active control of temperature to compensate for the spatially non-uniform and temporally-varying heat emitted from the heat-producing devices.

2. The microchip of claim 1, wherein the heat-producing electronic devices are CMOS devices.

3. The microchip of claim 1, wherein the heat-sensitive devices are either optical or electro-optical devices.

4. The microchip of claim 1, wherein the heat-producing electronic devices, the heat-sensitive devices, and the plurality of temperature control elements are disposed within a common layer on the substrate.

5. The microchip of claim 1, wherein the heat-producing electronic devices are disposed on a first side of the substrate and the heat-sensitive devices are disposed on a second, opposite side of the substrate.

6. The microchip of claim 1, wherein the temperature control elements and the heat-producing electronic devices are disposed within a common plane.

7. The microchip of claim 1, wherein the temperature control elements and the heat-sensitive devices are disposed within a common plane.

8. The microchip of claim 1, wherein the plurality of temperature control elements comprises at least one resistive heater.

9. The microchip of claim 1, wherein the plurality of temperature control elements comprises at least one thermoelectric cooler.

10. The microchip of claim 1, wherein the temperature control elements comprise at least one temperature sensor element as part of a closed-loop temperature control system.

11. The microchip of claim 1, further comprising an insulating layer interposed between the plurality of heat-producing electronic devices and the heat-sensitive devices.

12. A method of making a microchip having active temperature control, comprising:
providing a substrate;
forming a plurality of heat-producing electronic devices supported by the substrate;
forming a plurality of heat-sensitive devices supported by the substrate;
forming a plurality of temperature control elements spatially distributed relative to the heat-producing electronic devices and the heat-sensitive devices to enable active control of temperature to compensate for spatially non-uniform and temporally-varying heat emitted from the heat-producing electronic devices.

13. The method of claim 12, wherein forming the heat-producing electronic devices comprises forming a plurality of CMOS devices on the substrate.

14. The method of claim 12, wherein forming the heat-sensitive devices comprises:
forming a plurality of optical devices on a wafer; and
bonding the wafer to the substrate.

15. A method of active spatio-temporal control of heat flow within a microchip, comprising:
providing a microchip comprising a plurality temperature control elements distributed within a plurality of heat-producing electronic devices and a plurality of heat-sensitive devices;
operating the heat-producing electronic devices, whereby heat is emitted by the heat-producing electronic devices and conducted toward the heat-sensitive devices;
sensing a time-varying spatial distribution of temperature within the microchip; and
controlling the plurality of temperature control elements to compensate for the time-varying spatial distribution of temperature.

16. The method of claim 15, wherein sensing a time-varying spatial distribution of temperature comprises sensing a time-varying spatial distribution of temperature within a first region in which the heat-producing electronic devices are substantially disposed.

17. The method of claim 15, wherein sensing a time-varying spatial distribution of temperature comprises sensing a time-varying spatial distribution of temperature within a second region in which the heat-sensitive devices are substantially disposed.

18. The method of claim 15, wherein controlling the plurality of temperature control elements comprises continuously adjusting the operation of the temperature control elements based on the time-varying spatial distribution of temperature.

19. The method of claim 15, wherein controlling the plurality of temperature control elements comprises adjusting the plurality of temperature control elements based on a predicted time-varying spatial distribution of temperature.
